(19) United States
(12) Patent Application Publication
(10) Pub. No.: US 2024/0322512 A1
(43) Pub. Date: Sep. 26, 2024

(54) LASER PULSE SPECTRAL BROADENING APPARATUS, LASER SOURCE APPARATUS AND METHOD OF CREATING LASER PULSES

(71) Applicants: Deutsches EleKtronen-Synchrotron DESY, Hamburg (DE); GSI Helmholtzzentrum fuer Schwerionenforschung GmbH, Darmstadt (DE)

(72) Inventors: Christoph HEYL, Hamburg (DE); Tino LANG, Hamburg (DE); Marcus SEIDEL, Hamburg (DE)

(21) Appl. No.: 18/579,574

(22) PCT Filed: Jul. 6, 2022
(86) PCT No.: PCT/EP2022/068754

§ 371 Date: Jan. 16, 2024

(30) Foreign Application Priority Data
Jul. 16, 2021 (EP) 21186050.7

(51) Int. Cl. H01S 3/00; H01S 3/06; H01S 3/23

(52) U.S. Cl. CPC H01S 3/0057; H01S 3/0604; H01S 3/2383

(57) ABSTRACT

A laser pulse spectral broadening apparatus (100) for spectral broadening of laser pulses (1A) comprises a multi-pass cell device (10) with multiple mirror elements, which are arranged for providing a beam path (2) extending from an input section to an output section of the multi-pass cell device (10), wherein the mirror elements comprise focussing mirror elements having a concave curvature, and with a pulse spectral broadening device (20) including at least one optical non-linear medium (21) being arranged in the beam path (2) for spectral broadening of the laser pulses passing the pulse spectral broadening device (20), wherein the mirror elements have a configuration providing multiple passages of the beam path (2) through the pulse spectral broadening device (20), wherein the mirror elements further comprise folding mirror elements having a close to plane shape, wherein the absolute value of the radius of curvature of the folding mirror elements (11, 12) is larger than 10 m, the folding mirror elements span a folded collimation portion (3) of the beam path (2) and the beam path (2) has a degree of collimation along the whole collimation portion (3), such that an accumulated collimation portion Gouy phase parameter G_{col} in the collimation portion (3) is π/15<G_{col}<π//2, and the mirror elements are arranged such that an accumulated half round trip Gouy phase parameter Ghrt per half round trip through the multi-pass cell device (10) differs from n*π//2, with n being a natural number. Furthermore, a laser source apparatus and a method of creating laser pulses (1B), employing the laser pulse spectral broadening apparatus (100), are described.

### FIELD OF THE INVENTION

The invention relates to a laser pulse spectral broadening apparatus for spectral broadening of laser pulses. Furthermore, the invention relates to a laser source apparatus being provided with the laser pulse spectral broadening apparatus and to a method of creating laser pulses, wherein the laser pulse spectral broadening apparatus is employed. Applications of the invention are available e. g. in the fields of laser technology, in particular high-power laser devices, and optics.

### TECHNICAL BACKGROUND

In the present specification, reference is made to the following prior art illustrating the technical background of the invention:
[1] T. Nagy et al. in “Adv. Physics” X 6, 1845795 (2020).
[2] J. Schulte et al. in “Opt. Lett.” 41, 4511 (2016);
[3] L Lavenu et al. in “Opt. Lett.” 43, 2252 (2018);
[4] C. Grebing et al. in “Opt. Lett.” 45, 6250 (2020);
[5] M. Kaumanns et al. in “Opt. Lett.” 43, 5877 (2018);
[6] P. Balla et al. in “Opt. Lett.” 45, 2572 (2020);
[7] J. Song et al. in Appl. Phys. B 127, 50 (2021);
[8] K. Fritsch et al. in “Opt. Lett.” 43, 4643 (2018);
[9] J. Weitenberg et al. in “Opt. Express” 25, 20502 (2017);
[10] M. Kaumanns et al. in “Opt. Lett.” 46, 929, (2021);
[11] E. A. Khazanov et al. in “Physics-Uspekhi” 62, 1096 (2019);
[12] C. Heyl et al. in “Optica” 3, 75 (2016);
[13] D. R. Herriott et al. in “J. Opt. Soc. Am. B” 34, 1340 (2017);
[14] G. S. Engel et al. in “Opt. Lett.” 32, 704 (2007);
[15] F. Guichard et al. in “Optics Letters” Vol. 38, Issue 21, pp. 4437-4440 (2013);
[16] A. Klenke et al. in “Optics Letters” Vol. 39, Issue 12, pp. 3520-3522 (2014);
[17] U.S. Pat. No. 9,847,615 B2 (US 2017/0125964A1);
[18] M. Stanfield et al. in “Opt. Express” 29(6), 9123 (2021); and
[19] M. Ueffing et al. in “Optics Letters” 43, 2070 (2018).

Ultrashort laser pulses play a crucial role in many fields ranging from time- and frequency domain spectroscopy and strong-field physics to everyday-life applications, including surgery and welding. Generation and amplification of ultrashort pulses set constraints on their duration imposed by bandwidth limitations. The most common ultrafast laser platforms, in particular providing pulse energies in the mJ-regime and beyond, are nowadays Titanium:Sapphire (Ti:Sa) and Ytterbium (Yb)-based systems, providing amplified pulses with duration from a few tens of fs (Ti:Sa) to hundreds of fs (Yb). A common method to overcome this limitation is laser pulse post-compression [1], which offers a route to approach the fundamental pulse duration limit defined by the duration of a single half-cycle. Known post-compression methods rely on nonlinear spectral broadening and either simultaneous or subsequent temporal compression of the pulses.

Various spectral broadening methods have been commonly employed [1] including nonlinear propagation within a single or multiple plates, within photonic crystal fibers or hollow-core capillaries (HCC), filaments or slab-waveguides. Recently, a method based on nonlinear spectral broadening within a multi-pass cell (MPC) was introduced [2]. This method offers high transmission [3, 4], high-power handling [4], high beam quality [3, 5] and large compression ratios [5, 6] while being adaptable to a large variety of laser pulse parameters including durations from 10 ps [7] to few-cycles [6, 8] as well as pulse energies from μJ [9] to 112 mJ [10].

Up to now, a key challenge is the adaption of high-performance post-compression methods to high pulse energies. In particular, post-compression methods advancing into the Joule-class pulse energy regime could enable the application to strong-field physics with the potential to overcome peak power limitations of chirped-pulse amplification [11]. While approaches like HCC, MPC or filament-based methods can in principle be scaled to very high pulse energies [12], the required setup-sizes become impractically large. As an example, in a conventional Herriott-type MPC, high intensities occurring at the mirrors are avoided by increasing beam spots on the mirrors. Increasing the beam spot requires an extension of the setup size in order to keep the laser beam mode-matched to the eigenmode of the MPC, which has advantages for achieving good spectral broadening performance. Alternative pulse energy scaling approaches have employed thin films and have been tested using Joule-class pulses [11]. These methods suffer, however, from reduced beam quality compared to fiber and MPC-based methods and only small compression factors could be reached so far.

Other known methods of high pulse energy spectral broadening/compression employ spatial and/or temporal pulse multiplexing (see [15], [16]) as well as higher-order beam modes [10]. These methods reduce the intensity at the mirrors, thus allowing higher pulse energies, but requiring pulse splitting or mode modifications which are often unfavourable for applications. Furthermore, the multiplexing methods increase system complexity especially at large multiplexing factors.

A multi-pass cell device for spectrally broadening laser pulses and for non-linear pulse compression is described in [17]. The multi-pass cell device comprises curved mirrors spanning an optical resonator with an exclusively focussed beam path. For overcoming the limitation of the pulse power to less than the critical power of dielectrics, the non-linear phase provided for spectral broadening is divided into small steps which are separated by sections of the focussed beam path without non-linearity. The curved mirrors are configured such that the multi-pass cell device is operated in a stability range near stability edges of the optical resonator. Due to the Gouy phase parameters required for this configuration, so-called 4f-imaging and corresponding options for beam size changes are excluded with the multi-pass cell device of [17]. The focussed beam path of the multi-pass cell device of [17] can be folded by folding mirrors. Nevertheless, this multi-pass cell device still suffers from a large set-up size required for scaling to higher pulse energies, which may reach about 20 mJ in [17].

Multi-pass spectral broadening devices that allow large beam sizes at all or at least some of the employed mirrors without requiring an impractically large setup size are discussed in [18, 19]. As these methods, in contrast to [17], necessarily employ 4f-imaging configurations including completely collimated beam path sections with a Gouy phase close to zero, beam size changes are possible without setup-size adjustments. Energy scaling can be obtained by adjusting spot sizes on the mirrors. However, 4f-imaging requires an operation at the edge of the stability range and simultaneously provides an imaging condition which results in accumulative Kerr lensing effects, which impair the beam quality in the optical resonator. The setups described in [18, 19] support energy scaling at compact setup size, but they do not support simultaneously large compression factors and good beam quality and are thus not suitable for compressing high energy pulses while providing good beam quality when operating at large compression factors.

In summary, none of the conventional post-compression methods is capable of handling high energy pulses, like multi-100 mJ pulses, at large compression ratios, e. g. 10 and more, while employing laboratory-scale setup sizes, e.g. with a length below 5 m.

### OBJECTIVE OF THE INVENTION

The objective of the invention is to provide an improved laser pulse spectral broadening apparatus for spectral broadening of laser pulses, an improved laser source apparatus and/or an improved method of creating laser pulses, avoiding the disadvantages of conventional techniques. In particular, laser pulse broadening is to be enabled with a compact configuration, increased pulse energies, e. g. with pulses energies of several 100 mJ or even more, and/or large compression ratios, in particular without requiring complex spatial and temporal multiplexing methods.

### BRIEF SUMMARY OF THE INVENTION

The objective of the invention is solved by a laser pulse spectral broadening apparatus, a laser source apparatus and/or a method of creating laser pulses, comprising the features of the independent claims, respectively. Preferred embodiments and applications of the invention arise from the dependent claims.

According to a first general aspect of the invention, the above objective is solved by a laser pulse spectral broadening apparatus, being configured for spectral broadening of laser pulses. The laser pulse spectral broadening apparatus includes a multi-pass cell device comprising multiple mirror elements, which are arranged for providing a beam path extending from an input section to an output section of the multi-pass cell device. The input section and the output section may be provided e. g. by a hole in one of the mirror elements or by an additional pick-off mirror placed in the beam path. The mirror elements comprise focussing mirror elements having a concave curvature. Furthermore, the laser pulse spectral broadening apparatus comprises a pulse spectral broadening device including at least one optical non-linear medium being arranged in the beam path and being configured for spectral broadening of the laser pulses passing the pulse spectral broadening device, wherein the mirror elements have a configuration providing multiple passages of the beam path through the pulse spectral broadening device.

According to the invention, the mirror elements further comprise folding mirror elements having a close to plane shape, wherein the folding mirror elements span a folded collimation portion of the beam path and the beam path has a degree of collimation along the whole collimation portion, such that an accumulated collimation portion Gouy phase parameter G_{col} in the collimation portion is π/15<G_{col}<π/2. In other words, the configuration of the mirror elements, in particular the close to plane shape of the folding mirror elements, is selected such that the beam path is close to collimated along the whole collimation portion. Accordingly, the multi-pass cell device is configured with the folded collimation portion, i. e. the folding mirror elements are arranged and shaped such that a portion of the beam path within the multi-pass cell device has a close to parallel shape. The accumulated Gouy phase in the collimation portion in particular is determined by a long propagation distance, which can be obtained by folding the collimation portion.

Furthermore, according to the invention, the mirror elements are arranged such that an accumulated half round trip Gouy phase parameter Gₕᵣₜ per half round trip through the multi-pass cell device differs from n*π/2, with n being a natural number. The accumulated half round trip Gouy phase parameter Gₕᵣₜn can be calculated per half round trip through the multi-pass cell device, e. g. per pass from a center of the collimation portion via one focusing mirror to the center of the focusing portion.

In the collimation portion, the multi-pass cell device has a close to parallel outer shape of the light field mode(s). The terms “close to collimated” or “close to parallel” refer to the beam path shape with deviations from the ideal parallel beam path shape, i. e. from a beam path of the laser pulses with a Gouy phase parameter G≈0. In particular, the degree of collimation along the whole collimation portion deviates from ideal collimation, so that a 4f-imaging configuration (equivalent to operation at the stability edge), e. g. like in [18] or [19], is prevented. The deviation from the ideal parallel beam path shape results from imaging within the multi-pass cell device and from the folding mirror shape being adapted for spatially stable folding the beam path within the multi-pass cell device. The collimation portion includes a weak focus of the beam path determined by the above accumulated collimation portion Gouy phase parameter G_{col}. Accordingly, the folding mirror elements have the close to plane shape, wherein the term “close to plane” refers to a plane reflecting surface or a concave or convex reflecting surface with a radius of curvature being selected for enabling the spatially stable multi-pass circulations of laser pulses within the multi-pass cell device. Preferably, the absolute value of the radius of curvature of the close to plane folding mirror elements is larger than 10 m.

The restriction of the half round trip Gouy phase parameter Gₕᵣₜ to values different from n*π/2 and more specifically, G_{col}>π/15 prevents operation of the multi-pass cell device close to the stability edge at which the formation of homogeneous spatial beam profiles is no longer possible if large compression factors are targeted. Operation very close to the stability edge would cause an accumulative influence of Kerr-lensing by the nonlinear medium causing a distorted spatial beam profile. The restriction to G_{col}<π/2 prevents operation in regimes where the beam spots on the folding mirrors reach small sizes leading to mirror damage at high pulse energies.

According to a second general aspect of the invention, the above objective is solved by a laser source apparatus, being configured for creating laser pulses, comprising a laser source being arranged for creating primary laser pulses, and a laser pulse spectral broadening apparatus according to the first general aspect of the invention or an embodiment thereof, wherein the laser pulse spectral broadening apparatus is arranged for receiving and for spectral broadening of the primary laser pulses. Preferably, a beam mode of the laser source is matched to a light field mode, particularly preferred to an eigenmode, defined by the multi-pass cell device of the laser pulse spectral broadening apparatus, in particular in nonlinear operation conditions taking the lensing effect of at least one nonlinear medium into account or in linear operation conditions. Furthermore, particularly preferred, the multi-pass cell device itself is arranged for temporal compressing of the spectrally broadened laser pulses and/or a pulse compression device, being coupled with the multi-pass cell device, is arranged for receiving and for temporal compressing of the spectrally broadened laser pulses.

According to a third general aspect of the invention, the above objective is solved by a method of creating laser pulses, comprising the steps of creating primary laser pulses with a laser source, and spectrally broadening the primary laser pulses with a laser pulse spectral broadening apparatus according to the first general aspect of the invention or an embodiment thereof. Preferably, a beam mode of the laser source is matched to a light field mode defined by the multi-pass cell device of the laser pulse spectral broadening apparatus. Particularly preferred, creating the laser pulses includes temporally compressing the spectrally broadened laser pulses with the multi-pass cell device of the laser pulse spectral broadening apparatus and/or with a separate pulse compression device.

With the invention, the inventors have found a new multi-pass cell device configuration that enables mode-matched laser pulse circulation, i. e. a new operative configuration within the stability range of the multi-pass cell device, repeating the spatial laser beam profile after each circulation through the multi-pass cell device. Advantageously, using preferably a four- (or more) mirror geometry, the multi-pass cell device is arranged such that a large laser beam diameter is reached at all mirror elements of the multi-pass cell device. Due to the folded collimation portion, a long propagation path per circulation through the multi-pass cell device is obtained, thus enabling configurations with large beam size and large laser beam spot sizes on all folding mirrors elements, and thus allowing high pulse energies while utilizing all advantages of MPC-based spectral broadening as known from conventional techniques. In contrast to conventional techniques, the multi-pass cell device is suitable for spectral broadening applications with spot sizes supporting >1 J class laser pulses with durations in the ps or fs regime.

In particular in contrast to [17], the close to plane folding mirrors do not enclose a strong beam path focus, thus allowing the provision of large spot sizes on the mirrors. In addition, the invention allows the usage of rather compact mirror sizes despite the provision of a plurality of large beam spots per mirror element, in particular via a compact, in particular mutually overlapping, geometrical arrangement of the beam spots on the focusing and/or folding mirrors. Furthermore, the provision of the collimation portion in the multi-pass cell device allows employing a beam folding geometry resulting in a compact configuration of the laser pulse spectral broadening apparatus. Advantageously, the multi-pass cell device employed with the invention has the characteristic that the largest dimension of the setup does not necessarily scale with pulse energy, like for conventional Herriott-type MPCs or large core capillaries.

The invention relies on the repetitive nonlinear spectral broadening of laser pulses via multiple passages through at least one optical nonlinear medium arranged in the multi-pass cell device, preferably accompanied and/or followed by recompression, e. g. employing standard temporal pulse compression methods. The multi-pass cell device allows that a sufficiently large laser beam diameter is reached at all mirrors forming the multi-pass cell device thus mitigating mirror damage, which is limiting the maximum pulse energy in conventional techniques. Moreover, the inventors provide scaling routes outlining upscaling options to Joule-class laser pulses promising efficient compression of TW-class laser pulses, thus offering new perspectives for extreme nonlinear optics and high-field physics, while the largest setup-dimension can be reduced in comparison with prior art systems, e. g. according to [10].

As a further aspect of the invention, all multi-pass cell devices employed according to the invention can easily be pulse energy scaled by applying geometrical scaling relations, e. g. as discussed in [12], outlining in particular a linear scaling of setup length L and mirror radius of curvature R with E (i.e. L˜E and R˜E) and an inverse scaling of the gas density ρ (i.e. ρ˜1/E) for gas-filled multi-pass cell devices. For multi-pass cells employing a bulk nonlinear medium, similar scaling approaches can be applied. This enables further energy-upscaling at increased setup-size. In addition, by applying the same setup configuration at much smaller setup size, very compact post-compression devices can be constructed, in particular with characteristic dimensions in the cm range, e.g. for small pulse energies in the mJ to μJ regime.

According to a preferred embodiment of the invention (in the following: first embodiment), the focussing mirror elements span a focal portion of the beam path, wherein the focal portion includes at least one focus of the beam path. Furthermore, according to the first embodiment, the collimation portion and the focal portion are arranged adjacent to each other with the beam path being folded by the folding mirrors, wherein the laser pulses alternatingly pass the collimation portion and the focal portion. The focal portion preferably provides a multi-path section of the multi-pass cell device, wherein the focussing mirror elements are arranged for multiple, e. g. 5 to 10 or more, reflections of the beam path with one single focus per pass between each pair of focussing mirrors. Advantageously, the provision of the focal portion allows setting the multi-pass cell device configuration in the stability range of the multi-pass cell device with the half round trip Gouy phase parameter Gₕᵣₜ with 0<Gₕᵣₜ<π/2 or π/2<Gₕᵣₜ<π, with the half round trip Gouy phase parameter Gₕᵣₜ being calculated per half round trip through the multi-pass system (from the center of the collimated beam portion to the center of focused beam portion). Accordingly, the accumulated Gouy phase in one round trip through the multi-pass cell device is unequal to an integer multiple of π. As a further advantage, the focal portion in combination with the collimation portion provides the folded, compact configuration of the multi-pass cell device.

With the first embodiment of the invention, a large spot size on each mirror element is reached by employing the multi-pass cell device in which the laser pulses travel alternatingly along the collimated portion, wherein the laser pulses are reflected multiple times between the folding mirror elements, and the focal portion. The beam path is tightly focused in the focal portion and collimated (or close to collimated in the collimated portion. The collimated portion can be folded multiple times to enable long path lengths. This way, a beam preferably matched to the eigenmode of the multi-pass cell device comprises large spot diameters at all mirrors.

According to a particularly preferred variant of the first embodiment of the invention, the optical beam path has a first length L₂ from one of the focussing mirrors via the folded collimation portion to another one of the focussing mirrors which is different from a second length L₁ of the returning path between the focussing mirrors via the focal portion (4) with L₂≥L₁. The inventors have found that, deviating from [19], the longer collimation portion advantageously allows to operate the multi pass cell in a Gouy phase parameter range which allows to provide an improved beam quality.

According to an advantageous example, using nonlinear pulse propagation simulations derived from realistic experimental conditions, the inventors have numerically demonstrated e.g. compression of 120 mJ, 1 ps pulses at 1030 nm to <65 fs employing a compact setup of e. g. 2 m length with the configuration according to the first embodiment of the invention.

According to another, alternative preferred embodiment of the invention (in the following: second embodiment), the focussing mirror elements are arranged for reflecting end sections of the collimation portion back to the collimation portion, the beam path is free of a focus (i. e. there is no tight focus, while a beam waist resulting from close to collimated shape of the beam path may occur) and the multi-pass cell has the half round trip circulation Gouy phase parameter Gₕᵣₜ with π/15<Gₕᵣₜ<π/2, with the half round trip Gouy phase parameter Gₕᵣₜ being calculated per half of the pass through the multi-pass cell device from a center of the collimation portion via one of the focussing mirror elements back to the center of the collimation portion. Particularly preferred, if the optical non-linear medium is a gas within the multi-pass cell device, the multi-pass cell is configured with the half round trip circulation Gouy phase parameter Gₙ in the range π/4<Gₕᵣₜ<π/2. With the second embodiment, the half round trip circulation Gouy phase parameter Gₕᵣₜ is equal to the accumulated collimation portion Gouy phase parameter G_{col}. The inventors have found that a new part of the stability range of the multi-pass cell device can be employed with the above features of the second embodiment, wherein the multi-pass cell device is configured without any tight focus along the beam path thereof. The focussing mirrors reflecting the laser back to the collimated portion are sufficient for a stable operation of the multi-pass cell device.

Advantageously, using the configuration according to the second embodiment, the inventors have numerically demonstrated e.g. compression of 120 mJ, 1 ps pulses at 1030 nm to <35 fs employing a compact setup of e. g. 2 m length.

According to further preferred embodiments of the invention, the optical beam path along the collimation portion may be folded multiple times, particularly preferred 5 times or more, e. g. 10 times or more or even 100 times and or more. Multiple folding of the collimation portion, which in particular may be provided with the above first or second embodiments of the invention, has particular advantages for increasing the beam path length of the collimation portion in the multi pass cell, while keeping a compact configuration of the multi pass cell.

The at least one optical nonlinear medium of the pulse spectral broadening device may comprise a solid, e. g. a dielectric plate (for instance, made of glass) or a gaseous material, e. g. a gas in the multi-pass cell device or portions thereof. Further advantages of the invention result from a variety of configurations of the pulse spectral broadening device, which can be implemented separately or in combination with the laser pulse spectral broadening apparatus. According to a first variant, the pulse spectral broadening device, in particular the at least one optical non-linear medium thereof, can be arranged in the collimation portion. Accordingly, the at least one optical non-linear medium is passed by the collimated or close to collimated beam path. Advantageously, this allows a large beam diameter within the at least one optical non-linear medium, so that ionisation effects or a damage of the at least one optical non-linear medium can be avoided.

Alternatively or additionally, the pulse spectral broadening device, in particular the at least one optical non-linear medium thereof, can be arranged close to at least one of the focussing mirrors. This arrangement may have advantages for adjusting pulse broadening parameters, while still avoiding ionisation effects or damages of the at least one optical non-linear medium.

According to further alternative or additional variants, the pulse spectral broadening device may comprise a single optical non-linear medium or multiple optical non-linear media. The single optical non-linear medium has an advantage in terms of simplifying the configuration of the laser pulse spectral broadening apparatus and minimizing power losses. Employing multiple optical non-linear media has advantages resulting from distributing the optical nonlinearity within the multi-pass cell device and increasing the spectral broadening of the laser pulses, i. e. obtaining an enlarged spectral range of the broadened pulses.

With a further option, the pulse spectral broadening device may comprise a gas medium filling the entire multi-pass cell device. With this embodiment, a continuous distribution of the optical non-linearity within the multi-pass cell device is obtained in an advantageous manner and the spectral broadening of the laser pulses is further increased. Preferably, the multi-pass cell device is arranged in a chamber filled with the gas medium as nonlinear medium. Advantageously, the chamber allows a confinement of the gas around the multi-pass cell device with a predetermined pressure, which may be below, equal to or above atmospheric pressure. The gas medium can be combined with at least one solid optical non-linear medium.

According to a further preferred embodiment of the invention, the focussing mirror elements are provided by reflecting sections of two focusing mirrors, which are arranged with a distance relative to each other. Accordingly, two focussing mirrors are provided, each with a concave reflecting surface, which span the focal portion in a multi-pass configuration therebetween (first embodiment of the invention) or which reflect end sections of the collimation portion back to the collimation portion (second embodiment of the invention).

Alternatively or additionally, according to another preferred embodiment of the invention, the folding mirror elements are provided by reflecting sections of two folding mirrors, which are arranged with a distance relative to each other. Accordingly, two folding mirrors are provided, each with a flat or close to flat reflecting surface, which span the collimated portion in a multi-pass configuration therebetween (first and second embodiments of the invention).

With these embodiments, the laser pulse spectral broadening apparatus may comprise for instance only four large solid mirrors providing all mirror elements, so that the mechanical stability of the multi-pass cell device can be improved.

Preferably, the folding mirror elements are overlapping sections of the folding mirrors, and/or the focussing mirror elements are overlapping sections of the focussing mirrors. Advantageously, the mutually overlapping arrangement further improves the compactness of the multi pass cell configuration.

Alternatively, each of the mirror elements can be provided by a single focusing mirror or a single folding mirror. Thus, with a further embodiment of the invention, the focussing mirror elements are provided by a first group of focusing mirrors and a second group of focusing mirrors, wherein the first and second groups of focusing mirrors are arranged with a distance from each other. Additionally or alternatively, the folding mirror elements are provided by a first group of folding mirrors and a second group of folding mirrors, wherein the first and second groups of folding mirrors are arranged with a distance from each other. Using single focusing and/or folding mirrors offers advantages for specifically adjusting and/or exchanging a single mirror without changing the other mirrors. In addition, using single focussing and/or folding mirrors offers increased flexibility to minimize the beam angle of incidence at the focusing mirrors in order to minimize beam distortions caused by astigmatism.

With further alternative embodiments, single focusing and/or folding mirrors can be combined with large focusing and/or folding mirrors including multiple mirror elements.

The mirror elements, i. e. the larger focusing and/or folding mirrors or the single focusing and/or folding mirrors preferably comprise reflecting multi-layer, e.g. dielectric and/or semiconductor, surfaces or metallic surfaces or a combination of both, optionally being configured for applying a chirp to the laser pulses circulating in the multi-path cell device.

Advantageously, multiple multi-pass cell device geometries are available. According to a first variant of multi-pass cell device geometries, the folding mirror elements may provide a single line or multiple lines multi-pass pattern and/or the focussing mirror elements provide a single line or multiple lines multi-pass pattern (so called bow tie configuration of the multi-pass cell device). According to a second variant of multi-pass cell device geometries, the folding mirror elements provide a circular or elliptical multi-pass pattern and/or the focussing mirror elements provide a circular or elliptical multi-pass pattern (so called cylindrical configuration of the multi-pass cell device). In the case of the cylindrical configuration, the multi-pass cell device has a cylindrically symmetric arrangement. To enable folding towards the symmetry axis, the folding mirrors are designed to be slightly curved (convex), the beam is less well collimated in the collimation region with the cylindrical configuration.

The bow tie configuration has a particular advantage as the beam size can be kept approximately constant for all mirror reflections of the folding mirror elements and focusing mirror elements. Thus, larger pulse energies can be used. On the other hand, the cylindrical configuration has advantages in terms of the rotational symmetry of the multi-pass cell device, which minimizes laser beam distortions, like astigmatism.

According to a further advantageous embodiment of the invention, the folding mirror elements are arranged with a V configuration, wherein normal directions of the folding mirror elements enclose an inclination angle different from zero. The V-shaped arrangement of the mirror elements has a particular advantage as e. g. by using two mirrors elements in the V-shaped arrangement, many beam convolutions can be made possible in a compact design since the distance between adjacent reflection spots in the V-shaped arrangement is larger on one side of the collimation portion (for coupling/uncoupling), but smaller on the other side of the collimation portion (allowing partially overlapping beams).

The multi-pass cell device itself can be adapted for temporal compressing simultaneously with the spectral broadening of the laser pulses. To this end, at least one of the mirror elements preferably is a chirped mirror element. Advantageously, the at least one chirped mirror element fulfills a double function in terms of reflecting the laser pulses along the beam path of the multi-pass cell device and applying a frequency chirp to the laser pulses, resulting in the temporal compression thereof. Optionally, at longer wavelengths, temporal compression can be introduced by material dispersion into the beam path of the multi-pass cell device.

According to further advantageous embodiments of the laser pulse spectral broadening apparatus or the laser source apparatus, an overall length L of the multi-pass cell device may be L<50 m/J*E [J], with E being a pulse energy of the laser pulses. The overall length L is an extension of the multi-pass cell device along a longitudinal axis (z axis) thereof, e. g. an extension between end mirrors of the multi-pass cell device. As a preferred but not limiting range, the pulse energy of the laser pulses may in a range e. g. from 1 mJ to 10 J. Advantageously, the pulse energy-dependent upper length limit of the setup is a measure of compactness of the laser pulse spectral broadening apparatus which has not been reached by conventional multi-pass cells.

Features disclosed in the context of the laser pulse spectral broadening apparatus and the embodiments thereof also represent preferred features of the inventive laser source apparatus and/or method of creating laser pulses and the embodiments thereof, and vice versa. The aforementioned aspects and inventive and preferred features, in particular with regard to the configuration of and method of operating the laser pulse spectral broadening apparatus as well as the dimensions and compositions of individual optical components which are described in relation to the laser pulse spectral broadening apparatus, therefore also apply for the laser source apparatus and/or method of creating laser pulses. The preferred embodiments, variants and features of the invention described above are combinable with one another as desired.

### BRIEF DESCRIPTION OF THE DRAWINGS

Further details and advantages of the invention are described in the following with reference to the attached drawings, which schematically shown in:

FIG. 1: an example of a conventional multi-pass cell device (prior art);

FIG. 2: features of the first embodiment of the laser pulse spectral broadening apparatus according to the invention with the bow tie configuration;

FIG. 3: a stability diagram illustrating features of the multi-pass cell devices employed according to the invention;

FIG. 4: results of numerical simulations of the maximum peak power and energy of laser pulses created according to the invention;

FIG. 5: features of the first embodiment of the laser pulse spectral broadening apparatus according to the invention with the cylindrical configuration;

FIG. 6: features of the second embodiment of the laser pulse spectral broadening apparatus according to the invention with the bow tie configuration; and

FIG. 7: features of an embodiment of the laser source apparatus according to the invention.

### PREFERRED EMBODIMENTS OF THE INVENTION

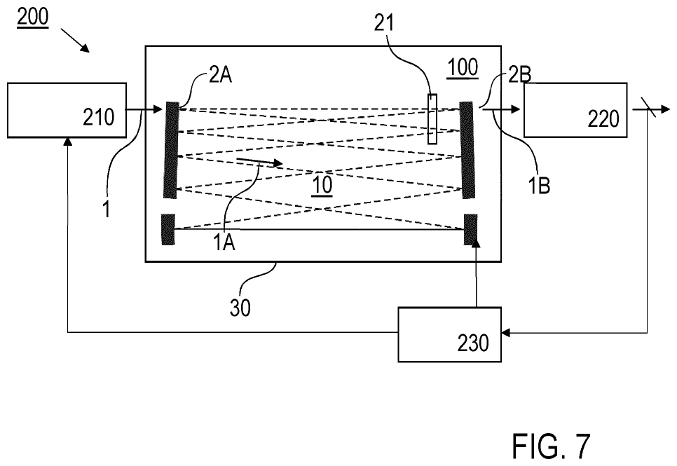

Features of preferred embodiments of the invention are described in the following with exemplary reference to embodiments, wherein the multiple mirror elements of the multi-pass cell device are provided by surface sections of large mirrors. It is emphasized that the laser pulse spectral broadening apparatus may be configured in corresponding manner with single mirrors each providing one of the mirror elements. Reference is made in particular to the configuration of the multi-pass cell device. Details of a laser source creating the laser pulses and an optional pulse compressing device (see FIG. 7) can be selected as it is known from conventional techniques.

As an example, reference is made to configurations, wherein the longitudinal axis of the multi-pass cell device (z axis) extends parallel to a surface of a carrier platform supporting the multi-pass cell device, with normal directions of the mirror elements being aligned parallel or slightly inclined relative to the z axis, the carrier platform surface extending e. g. in an x-z-plane of a Cartesian system and groups of mirror elements of collimation and focal portions of the multi-pass cell device extending in x-y-planes perpendicular to the carrier platform surface. It is emphasized that the implementation of the invention in practice is not restricted to this spatial orientation.

Furthermore, the particular components, configurations, parameters and processes can be varied in dependence on the application conditions of the invention.

In the following, general pulse energy scaling principles of the multi-pass cell device and embodiments of multi-pass cell types are discussed which enable large beam spot sizes at all mirror surfaces and operation at high pulse energies while keeping the setup size compact. The analytical analysis is supported by numerical simulations. It shows that in particular highly efficient MPC-based pulse-post compression at large compression ratios can be extended to several 100 mJ pulse energies and multi-TW peak powers using a table-top setup.

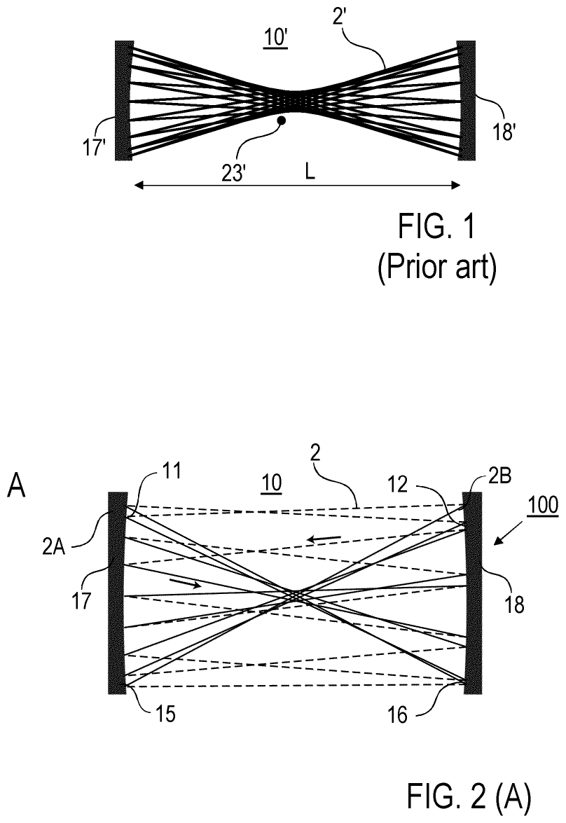

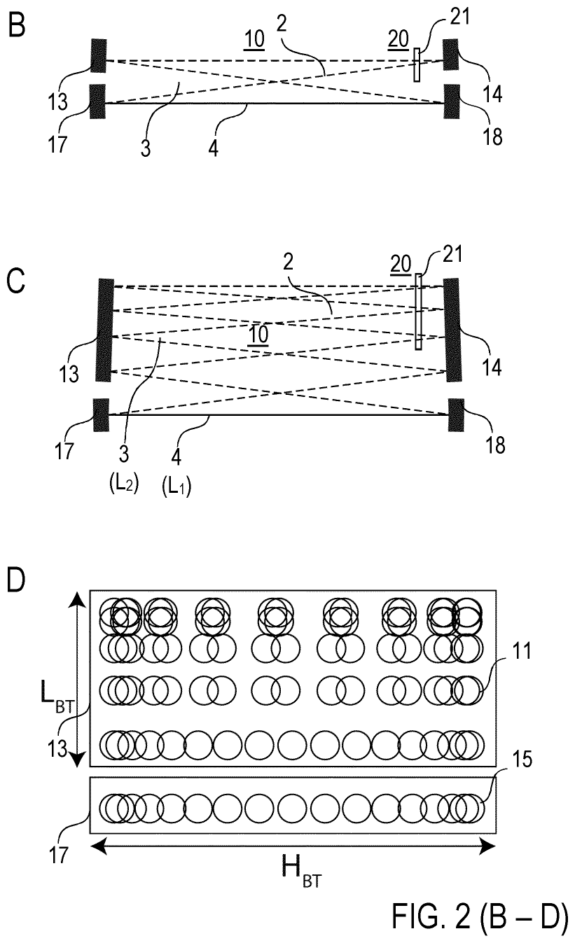

Firstly, reference is made to a conventional multi-pass cell device as shown in FIG. 1. Subsequently, embodiments of the inventive laser pulse spectral broadening apparatus 100 are described with particular reference to the design of the multi-pass cell device thereof, as shown in FIGS. 2 to 6. Features of the laser source device 200 including the laser pulse spectral broadening apparatus 100 are described with reference to FIG. 7.

FIG. 1 illustrates a standard Herriott-type multi-pass cell device 10′ (prior art, see e. g. [13]) with two identical concave large mirrors 17′, 18′ with radius of curvature R placed at a distance L and multiple foci in the center therebetween (one focus per pass). The multi-pass cell device 10′ is filled with a gas as optical nonlinear medium 23′. Alternatively, the multi-pass cell device 10′ can be partially filled with nonlinear media, such as one or more anti-reflection coated fused silica windows or glass plates. A reentrant beam pattern with a repeating beam path 2′ after N round trips through the multi-pass cell device 10′ can be reached by obeying the following relation for the ratio C of L and R (see [14]):

$$C = \frac{L}{R} = 1 - cos ( π k / N ) \qquad ( 1 )$$

where k=1, . . . , (N-1) denotes a variable integer. In order to obtain a q-preserving multi-pass cell device (with q defining the complex beam parameter) ensuring similar nonlinear pulse propagation characteristics for each round trip, the input beam needs to be mode-matched to the eigenmode of the multi-pass cell, which is identical to the mode of a corresponding cavity formed by the two-mirror arrangement.

For nonlinear spectral broadening, an optical nonlinear medium, such as the gas 23′ or a glass plate is inserted into the multi-pass cell device 10′. Considering nonlinear pulse propagation determined by self-phase modulation governed by the nonlinear refractive index change Δn=n₂l, where n₂ is the instantaneous nonlinear refractive index and l the light pulse intensity, the pulse energy can be increased while decreasing n₂ until the mirror damage threshold or a focus intensity leading to ionization of the gas is reached. For pulse-energy upscaling, the usage of the gas as optical nonlinear medium 23′ provides advantages compared to solids including immunity to damage, a smaller refractive index and the ability to handle higher peak intensities. Moreover, the gas pressure p provides a simple way to tune n₂˜p. Bulk media, on the other hand, provide advantages as they can more easily be localized to a section in the MPC where the intensity is sufficiently low to avoid damage or ionization.

Taking the example of a multi-pass cell device 10′ with R=1 m operated close to the stability edge with k=14, N=15, λ=1030 nm, a pulse width t=1 ps, and considering a mirror damage threshold of Fₜₕ=500 mJ/cm², an energy limit of 24.5 mJ and a corresponding peak focus intensity of 4.6*10¹³ W/cm² is obtained. The corresponding MPC length amounts to L=R*C=1.978 m.

In order to increase the pulse energy beyond this limit while enabling operation employing a fundamental Gaussian beam mode, multiple tuning parameters can be identified: N, λ and R. For increasing N, Fₘ but also the focus intensity I₀ increase. While the fluence limit can thus be circumvented, ionization effects in the focus will limit the maximum pulse energy for gas-filled multi-pass cell devices. In addition, operation of the MPC very close to the stability edge (C≈2) implies increased sensitivity to perturbations. In addition, the MPC imaging properties at the stability edges will prevent homogenization of the spatial beam profile when C≈2 (equivalent to Gₕᵣₜ=π) is reached—one of the most advantageous properties of nonlinear MPCs. Larger pulse energies can also be reached for longer wavelengths.

The practically most relevant pulse energy tuning option for the conventional multi-pass cell device 10′ is provided by the setup size, showing a straightforward linear scaling relation between setup size and maximum pulse energy. For gas-filled MPCs it can be shown that this energy scaling method obeys fully scale-invariant characteristics providing spectral broadening properties which do not depend on the laser pulse energy if setup size and gas density are scaled according to basic relations outlined in Ref. [11].

With the invention, as illustrated in FIGS. 2 to 7, pulse energy scaling options beyond the above limits are introduced. By utilizing principles applied to optical resonator design relating long resonator lengths with large mode sizes, the inventors have found folded long path-length multi-pass cell devices of compact size. If the folding mirrors are only placed in sections of large beam size (collimation portion), high pulse energies can be supported as described in the following.

According to FIG. 2, the conventional two mirror multi-pass cell device of FIG. 1 is replaced by a four-mirror multi-pass cell device 10, being arranged e. g. in the bow-tie configuration. FIG. 2A shows a side view and FIGS. 2B and 2C show two exemplary top views of different variants of the first embodiment of the multi-pass cell device 10. The beam path 2 is displayed in a simplified configuration in FIG. 2A, i.e. depicting straight beam paths (dashed lines) instead of folded beam paths between focusing mirrors 17 and 18 within the collimated section of the multi-pass device.

With more details, the laser pulse spectral broadening apparatus 100 of FIG. 2 comprises the multi-pass cell device 10 with multiple mirror elements 11, 12, 15 and 16 provided by a pair of folding mirrors 13, 14 and a pair of focussing mirrors 17, 18. The mirror elements 11, 12, 15 and 16 span a beam path 2 extending from an input section, e. g. at 2A, to an output section, e. g. at 2B, provided e.g. by holes in the folding mirrors 13, 14. The laser pulse spectral broadening apparatus 100 of FIG. 2 represents the first embodiment of the invention, i. e. the folding mirror elements 11, 12 (provided by the folding mirrors 13, 14) span a collimation portion 3 of the beam path 2, and the focussing mirror elements 15, 16 (provided by the focussing mirrors 17, 18) span a focal portion 4 of the beam path 2.

The mirror elements 11, 12, 15 and 16 are sections of the folding mirrors 13, 14 and focussing mirrors 17, 18, where the beam path 2 is reflected (as illustrated with exemplary mirror elements 11 and 15 by the beam path spots formed on the mirrors 13 and 17 in FIG. 2D). Depending on the position along the height H_{BT} and lengths L_{BT} of the mirrors 13 and 17 within the multi-pass cell device 10, the mirror elements 11 and 15 may be separate sections of the folding mirrors 13, 14 and focussing mirrors 17, 18 or overlapping sections of the folding mirrors 13, 14 and focussing mirrors 17, 18.

The folding mirrors 13, 14 comprise close to plane mirrors being arranged with a V configuration, i. e. the folding mirrors 13, 14 are not parallel to each other, but rather inclined with the normal directions of the mirror surfaces deviating from each other. The focussing mirrors 17, 18 have an identical concave curvature.

A pulse spectral broadening device 20 is provided by an optical non-linear medium 21 formed by a dielectric plate, e. g. made of glass with a thickness of 0.5 mm. The optical non-linear medium 21 is arranged in the collimation portion 3 for spectral broadening of the laser pulses with each pass through the dielectric plate.

With the multi-pass cell device 10 of FIG. 2, the optical beam path 2 has a first length L₂ from focussing mirror 17 via the folded collimation portion 3 to focussing mirror 18 which is different from a second length L₁ of the returning path from focussing mirror 18 via the focal portion 4 to focussing mirror 17 (see FIG. 2C). For example, L₂≈3 L₁ in FIG. 2B and L₂≈9 L₁ in FIG. 2C. The multi-pass cell device 10 of FIG. 2 has a half round trip Gouy phase parameter Gₕᵣₜ=π*4/9. (Gₕᵣₜ being calculated per pass from a center of the collimation portion 3 via one focusing mirror to the center of the focusing portion 4).

Without loss of generality, L₂≥L₁ is assumed in the following. Similar to equation 1, a general equation describing the solutions for a reentrant beam pattern in multi-pass cell device 10 of FIG. 2 with two identical concave mirrors 17, 18 of radii R can be derived:

$${C}_{1} + {C}_{2} - {C}_{1} {C}_{2} = {sin}^{2} ( π k / N ) \qquad ( 2 )$$

$$with$$

$$k = 1 , 2 , … N ,$$

with C₁=L₁/R and C₂=L₂/R defined analogously to equation 1.

With a practical implementation, the multi-pass cell device 10 of FIG. 2 is configured e. g. with the following parameters: dimensions of the folding mirrors 13, 14: L_{BT}*H_{BT}=10 cm*10 cm, dimensions of the focussing mirrors 17, 18: 5 cm*10 cm, radius of curvature of the focussing mirrors 17, 18: 1 m, folding mirrors 13, 14: plane mirrors, number of passes along the collimation portion 3: 9×9=81 (9 circulations through the system, 9-times folded beam path along the collimated portion), number of passes along the focal portion 4: 9, path length L₂=9 m, path length L₁=1.0038 m, corresponding to N=9 and k=4. The overall length L of the multi-pass cell device 10 (measured like in FIG. 1) is e. g. 1 m.

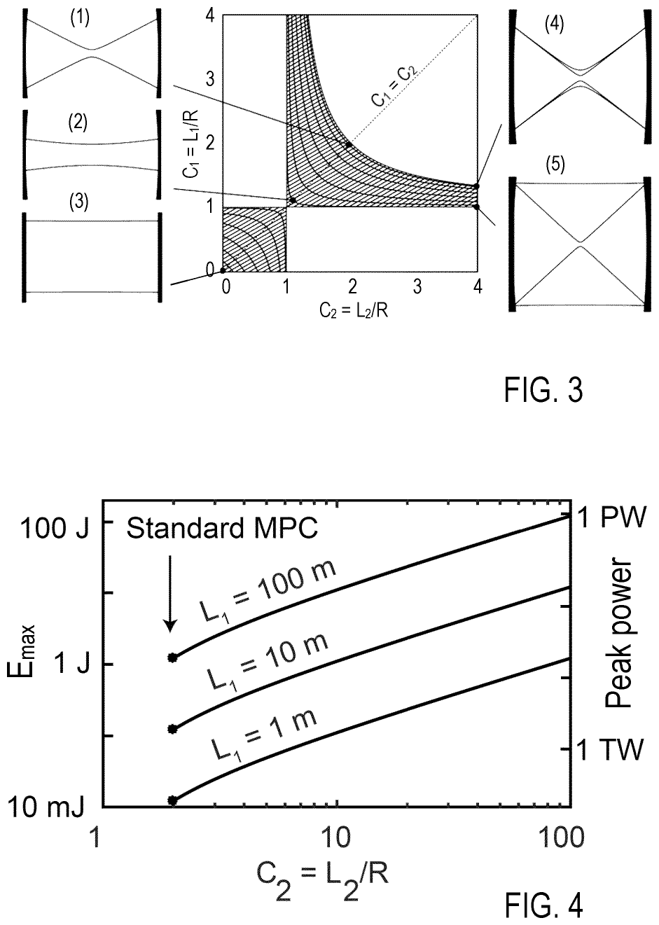

FIG. 3 shows the stability diagram for the bow tie configuration of the multi-pass cell device 10 (FIG. 2). The standard MPC parameter space with L₁=L₂ is indicated with a dotted diagonal line. Cavity modes (grey areas) are illustrated schematically for five important example configurations (enlarged vertical dimension for better mode visibility) for constant L₁ and different R (panels (1) to (5)).

The solution of equation 2, i.e. the function C₁(C₂) is shown in FIG. 3 using the example of N=15 for k=1, 2, . . . , 5, 6, 7 (black solid lines). Equation 2 defines again (N-1) solutions, each solution appearing twice. It is therefore sufficient to consider k=1, 2, . . . , N/2. The white areas in FIG. 3 mark regions outside the stability range.

Equation 2 convergences towards equation 1 for L₁=L₂, i.e. the crossing points of the solutions C₁(C₂) with the diagonal line C₁=C₂ (equivalent to L₁=L₂) represent the standard two-mirror Herriott cell (FIG. 1).

The collimated beam in the collimation portion 3, i. e. along L₂, brings along an important advantage of the invention: the beam path along L₂ can be folded even multiple times without increasing the maximum mirror fluence, providing broad range of variants for the construction of compact Multi-pass cell devices as the system length is only be determined by L₁ with L₁ a R for large C₂.

At large asymmetries L₂/L₁, the collimation portion 3 along L₂ is preferably folded many times in order to keep the system compact, which is easily possible using todays multi-layer mirror technology supporting pulse durations of 30 fs and below with losses at the few-part per million level thus enabling system transmission above 90% even for beam paths folded 100 times and more.

While the beam spot size at the mirror surface increases with L₂ causing a decreasing fluence, the focus peak intensity at the tighter focus intersected by L₁ increases. Ionization at the tight focus of the multi-pass cell device 10 can be avoided by operation inside a closable chamber at a low residual gas-pressure. For spectral broadening an optical nonlinear medium is placed within another section of the multi-pass cell device 10 (see e. g. FIGS. 2B, C). This could be either a solid medium 21 placed e.g. in the collimation portion 3 along L₂ and/or a gas medium separated from the location of the tight focus via differential pumping.

FIG. 4 illustrates results of a numerical estimate of the maximum pulse energy and peak power of broadened and temporally compressed laser pulses in dependence on the parameter C₂=L₂/R, i. e. the length of the collimation portion 3 divided by the radius of curvature of the focussing mirrors 17, 18, for various examples of the length L₁ of the focal portion 4 assuming a laser wavelength of 1030, a mirror fluence limit of 0.5 J/cm² and a geometrical configuration defined by equation 2 with k=7 and N=15. The peak power was calculated with the simplification of assuming a perfect temporal Gaussian pulse shape and a compressed pulse duration of 65 fs. The numerical estimates displayed in FIG. 4 are obtained assuming operation of the multi-pass cell device using linear mode-matching approaches. Depending on the operation regime, nonlinear mode-matching might be required for optimum performance, resulting in deviations from the displayed parameters due to changed beam spot sizes. Both graphics demonstrate the energy scaling capability of the inventive laser pulse spectral broadening apparatus 100.

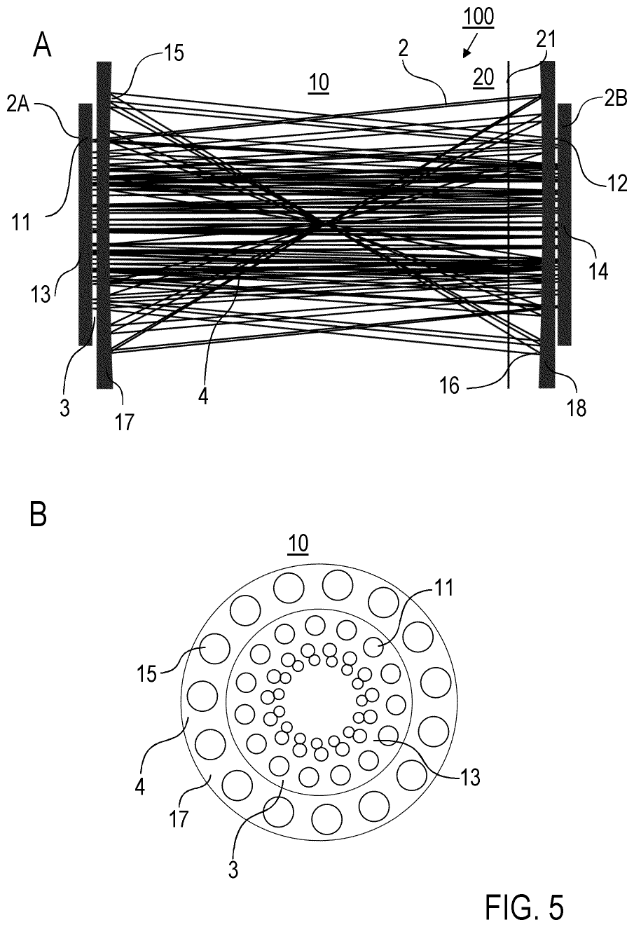

The invention is not restricted to the bow tie configuration of the multi-pass cell device 10 according to FIG. 2. As an alternative, a cylindrical configuration can be employed with the first embodiment of the invention, as shown in FIG. 5.

The multi-pass cell device 10 of the laser pulse spectral broadening apparatus 100 of FIG. 5A comprises multiple mirror elements 11, 12, 15 and 16 provided by a pair of plane or close to plane folding mirrors 13, 14 and a pair of ring-shaped curved focussing mirrors 17, 18. The focussing mirrors 17, 18 have an identical concave curvature. The mirror elements 11, 12, 15 and 16 span the beam path 2 extending from an input section, e. g. at 2A, to an output section, e. g. at 2B, provided e.g. by holes in the focussing mirrors 17, 18 and having a spot pattern as shown in FIG. 5B. The beam path 2 comprises the collimation portion 3 spanned by the folding mirrors 13, 14 and the focal portion 4 spanned by the focussing mirrors 17, 18. The multi-pass cell device 10 of FIG. 5 has a Gouy phase parameter Gₕᵣₜ=π*8/15. (Gₕᵣₜ being calculated per pass from the center of the collimation portion 3 via one focusing mirror to the center of the focusing portion 4).

As mentioned with reference to FIG. 2, the mirror elements 11, 12, 15 and 16 are sections of the folding mirrors 13, 14 and focussing mirrors 17, 18, where the beam path 2 is reflected (illustrated by the beam path spots formed on the mirrors 13 and 17 in FIG. 5B). Depending on the position within the multi-pass cell device 10, the mirror elements 11 and 15 may be separate sections of the folding mirrors 13, 14 and focussing mirrors 17, 18 or overlapping sections of the folding mirrors 13, 14 and focussing mirrors 17, 18.

The optical non-linear medium 21 of the pulse spectral broadening device 20 is a dielectric plate, e. g. made of glass with a thickness of 0.5 mm, which is arranged in the collimation portion 3 for spectral broadening of the laser pulses with each pass through the dielectric plate.

With a practical implementation, the multi-pass cell device 10 of FIG. 5 is configured e. g. with the following parameters: diameter of the folding mirrors 13, 14: 140 mm, outer diameter of the ring shaped focussing mirrors 17, 18: 200 mm, inner diameter of the ring shaped focussing mirrors 17, 18: 140 mm, radius of curvature of the focussing mirrors 17, 18: 1 m, radius of curvature of the folding mirrors 13, 14: −10 m (weakly convex mirror), number of passes along the collimation portion 3: 105 (15 circulations through the system which is folded 7 times), number of passes along the focal portion 4: 15, distance between focusing mirrors: 1.17 m, distance between folding mirrors 1.25 m, corresponding to N=15. The overall length L of the multi-pass cell device 10 is e. g. 1.17 m.

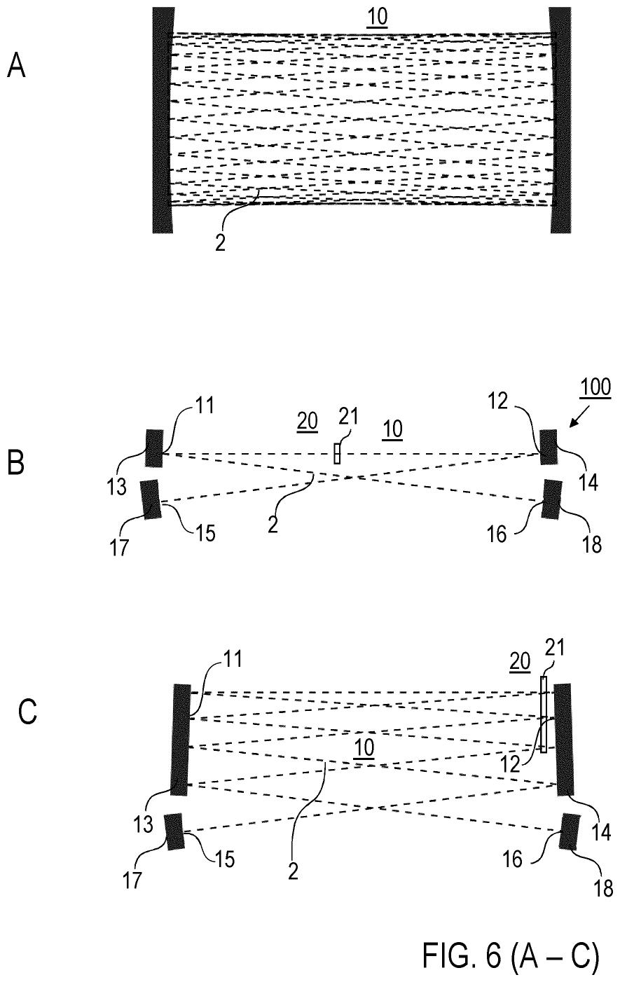

FIG. 6 illustrates features of the second embodiment of the invention, wherein the beam path 2 of the multi-pass cell device 10 is free of a tight focus. The multi-pass cell device 10 comprises a pair of folding mirrors 13, 14, each with a plurality of folding mirror elements 11, 12 spanning the collimation portion 3 of the multi-pass cell device 10. The collimation portion 3 includes the optical non-linear element 21 of the pulse spectral broadening device 20. Furthermore, the multi-pass cell device 10 comprises a pair of focussing mirrors 17, 18 with a plurality of focussing mirror elements 15, 16 which are arranged for reflecting end sections of the collimation portion 3 back to the collimation portion 3. FIG. 6A shows a side view of the multi-pass cell device 10, and FIGS. 6B and 6C show top views of the multi-pass cell device 10 with L₂≈3L₁ and L₂≈9L₁ (L₂: lengths of the collimation portion, L₁: distance of the focussing mirrors). The multi-pass cell device 10 of FIG. 6 has a half round trip Gouy phase parameter Gₕᵣₜ=π*2/15. (Gₕᵣₜ being calculated per half of the pass from the center of the collimation portion 3 via one focusing mirror back to the center of the collimation portion 3).

With a practical implementation, the multi-pass cell device 10 of FIG. 6 is configured e. g. with the following parameters: dimensions of the folding mirrors 13, 14: 25 cm*18 cm, dimensions of the focussing mirrors 17, 18: 5 cm*18 cm, radius of curvature of the focussing mirrors 17, 18: 231 m, folding mirrors 13, 14: plane mirrors, number of passes along the collimation portion 3: 30*11 (15 circulations through the system yielding 30 passes though the collimated beam section which is folded 11 times), folded optical path length between the two focusing mirrors: 20 m, corresponding to k=2 and N=15. Accordingly, the overall length L of the multi-pass cell device 10 is e. g. 20 m/11=1.818 m.

The embodiment of FIG. 6 provides large beam spot sizes while enabling compact setup sizes, combining folded collimated beam paths as utilized for the first embodiment of FIGS. 2 to 5. For k/N→0, the beam between both mirrors of a conventional MPC would approach a collimated geometry, as illustrated in panel (3) of FIG. 3.

In contrast to the conventional MPC, e. g. according to FIG. 1, operated close to the outer stability edge (k/N≈1), the multi-pass cell device employed according to the invention can be folded using folding mirrors 13, 14 similar to the collimating portion 3 of the multi-pass cell device 10 of FIG. 2, but without limiting Eₘₐₓ. This way, a compact setup can be constructed supporting high pulse energies, requiring, however, mirrors with very long radius of curvature.

As an example, for Fₘ=0.5 mJ/cm², N=15, λ=1030 nm, R=231 m and a folded optical path length between the two focusing mirrors L=20 m, a pulse energy of about 120 mJ would be supported. The setup size can, however, be very compact as the beam path can be folded multiple times along the length L of the beam path 2.

With a further practical implementation, the multi-pass cell device of FIG. 6 can also be configured in a down-scaled configuration e.g. with the following parameters: dimensions of the folding mirrors 13, 14: 6 cm*4 cm, dimensions of the focusing mirrors 17, 18: 1 cm*4 cm, radius of curvature of the focusing mirrors 17, 18: 11.5 m, folding mirror 14, 14: close to plane mirrors, number of passes along the collimation portion 3: 30*11 (15 circulations through the system yielding 30 passes though the collimated portion which is folded 11 times), folded optical path length between the two focusing mirrors: 1 m, corresponding to k=2 and N=15.

As an example, for the above-mentioned parameter set, i.e. with Fₘ=0.5 mJ/cm², N=15, λ=1030 nm, R=231 m and a folded optical path length between the two focusing mirrors L=1 m (equal to the overall length L of the multi-pass cell device 10), a pulse energy of about 6 mJ would be supported. The setup size can, however, be very compact with a footprint of the beam propagation area of only about 6*10 cm, yielding a total footprint of only about 10*16 cm for the total setup.

FIG. 7 schematically illustrates an embodiment of a laser source apparatus 200 for creating laser pulses. The laser source apparatus 200 comprises a laser source 210, like a ps or sub-ps Ytterbium:YAG laser for creating primary laser pulses 1 to be broadened. The laser source 210 is coupled with the laser pulse spectral broadening apparatus 100 according to the invention, e. g. according to FIG. 2, 5 or 6, being arranged in a closed, evacuable chamber 30. The laser pulse spectral broadening apparatus 100 receives the laser pulses 1 via an input section 2A, like a hole in one of the mirrors, and applies spectral broadening by multiple nonlinear interactions of the laser pulses 1A, which circulate in the multi-pass cell device 10, with the optical non-linear medium 21.

A pulse compression device 220 is arranged downstream of the output section 2B of the multi-pass cell device 10 for receiving the spectrally broadened laser pulses 1B via an output section 2B, like a hole in another one of the mirrors, and for temporal compressing of the spectrally broadened laser pulses 1B. Pulse compression is implemented with the pulse compression device 220 with a method as known in prior art, e. g. using temporal pulse compression with chirped mirrors. The pulse compression device 220 can be omitted if temporal pulse compression is not required or if temporal pulse compression is introduced in the laser pulse spectral broadening apparatus 100.

FIG. 7 additionally shows an optional control device 230, which is coupled via a sensor (not shown) with the output of the laser pulse spectral broadening apparatus 100 or the pulse compression device 220. The control device 230 is arranged for adjusting at least one of the mirror elements of the multi-pass cell device 10 (e.g. the position of the mirror) and/or the laser source 210 in dependence on the spectrally broadened and optionally compressed laser pulses, e. g. temporal, spectral and/or amplitude features thereof. Thus, with a control loop including the control device 230, the pulse parameters can be optimized.

The features of the invention disclosed in the above description, the drawings and the claims can be of significance individually, in combination or sub-combination for the implementation of the invention in its different embodiments.

1. A laser pulse spectral broadening apparatus, being configured for spectral broadening of laser pulses, comprising
a multi-pass cell device comprising multiple mirror elements, which are arranged for providing a beam path extending from an input section to an output section of the multi-pass cell device, wherein the mirror elements comprise focusing mirror elements having a concave curvature, and
a pulse spectral broadening device including at least one optical non-linear medium being arranged in the beam path and being configured for spectral broadening of the laser pulses passing the pulse spectral broadening device, wherein the mirror elements have a configuration providing multiple passages of the beam path through the pulse spectral broadening device, wherein
the mirror elements further comprise folding mirror elements having a close to plane shape, wherein an absolute value of the radius of curvature of the folding mirror elements is larger than 10 m, the folding mirror elements span a folded collimation portion of the beam path and the beam path has a degree of collimation along the whole collimation portion, such that an accumulated collimation portion Gouy phase parameter G_{col} in the collimation portion is π/15<G_{col}<π/2, and
the mirror elements are arranged such that an accumulated half round trip Gouy phase parameter Gₕᵣₜ per half round trip through the multi-pass cell device differs from n*π/2, with n being a natural number.

2. The laser pulse spectral broadening apparatus according to claim 1, wherein
the focusing mirror elements span a focal portion of the beam path, wherein the focal portion includes at least one focus of the beam path, and
the collimation portion and the focal portion are arranged adjacent to each other, with the beam path being folded by the folding mirror elements, wherein the collimation portion and the focal portion are arranged such that the laser pulses alternatingly pass the collimation portion, wherein the laser pulses are reflected multiple times between the folding mirror elements, and the focal portion.

3. The laser pulse spectral broadening apparatus according to claim 2, wherein
the optical beam path has a first length L₂ from one of the focusing mirrors via the folded collimation portion to another one of the focusing mirrors which is different from a second length L₁ of the returning path between the focusing mirrors via the focal portion with L₂≥L₁.

4. The laser pulse spectral broadening apparatus according to claim 1, wherein
the focusing mirror elements are arranged for reflecting end sections of the collimation portion back to the collimation portion,
the beam path is free of a focus, and
the multi-pass cell device has the accumulated half round trip Gouy phase parameter Gₕᵣₜ with π/15<Gₕᵣₜ<π/2.

5. The laser pulse spectral broadening apparatus according to claim 1, wherein
the optical beam path along the collimation portion is folded multiple times.

6. The laser pulse spectral broadening apparatus according to claim 1, wherein
the pulse spectral broadening device is arranged in the collimation portion.

7. The laser pulse spectral broadening apparatus according to claim 1, wherein
the pulse spectral broadening device is arranged close to at least one of the focusing mirror elements.

8. The laser pulse spectral broadening apparatus according to claim 1, wherein
the pulse spectral broadening device comprises multiple optical non-linear media.

9. The laser pulse spectral broadening apparatus according to claim 1, wherein
the pulse spectral broadening device comprises a gas medium filling the entire multi-pass cell device.

10. The laser pulse spectral broadening apparatus according to claim 1, wherein
the folding mirror elements are provided by reflecting sections of two folding mirrors, which are arranged with a distance relative to each other.

11. The laser pulse spectral broadening apparatus according to claim 10, wherein
the folding mirror elements are overlapping sections of the folding mirrors.

12. The laser pulse spectral broadening apparatus according to claim 1, wherein
the focusing mirror elements are provided by reflecting sections of two focusing mirrors, which are arranged with a distance relative to each other.

13. The laser pulse spectral broadening apparatus according to claim 12, wherein
the focusing mirror elements are overlapping sections of the focusing mirrors.

14. The laser pulse spectral broadening apparatus according to claim 1, wherein
the folding mirror elements are provided by a first group of folding mirrors and a second group of folding mirrors, wherein the first and second groups of folding mirrors are arranged with a distance from each other.

15. The laser pulse spectral broadening apparatus according to claim 1, wherein
the focusing mirror elements are provided by a first group of focusing mirrors and a second group of focusing mirrors, wherein the first and second groups of focusing mirrors are arranged with a distance from each other.

16. The laser pulse spectral broadening apparatus according to claim 1, wherein
the folding mirror elements provide a single line or multiple lines multi-pass pattern and/or the focusing mirror elements provide a single line or multiple lines multi-pass pattern.

17. The laser pulse spectral broadening apparatus according to claim 1, wherein
the folding mirror elements provide a circular or elliptical multi-pass pattern.

18. The laser pulse spectral broadening apparatus according to claim 1, wherein
the focusing mirror elements provide a circular or elliptical multi-pass pattern.

19. The laser pulse spectral broadening apparatus according to claim 1, wherein
the folding mirror elements are arranged with a V configuration, wherein normal directions of the folding mirror elements enclose an inclination angle different from zero.

20. The laser pulse spectral broadening apparatus according to claim 1, wherein
the optical non-linear medium comprises at least one transparent plate, being transparent at the full spectral range of the broadened laser pulses.

21. The laser pulse spectral broadening apparatus according to claim 1, wherein
at least one of the mirror elements is a chirped mirror element.

22. The laser pulse spectral broadening apparatus according to claim 1, wherein
the multi-pass cell device is arranged in a chamber filled with a gas as nonlinear medium.

23. A laser source apparatus, being configured for creating laser pulses, comprising
a laser source being arranged for creating primary laser pulses, and
a laser pulse spectral broadening apparatus according to claim 1, being arranged for receiving and for spectral broadening of the primary laser pulses.

24. The laser source apparatus according to claim 23, wherein
a beam mode of the laser source is matched to a light field mode defined by the multi-pass cell device in nonlinear operation conditions taking a lensing effect of the at least one optical nonlinear medium into account or in linear operation conditions.

25. The laser source apparatus according to claim 23, wherein
a pulse compression device is arranged for receiving and for temporal compressing of the spectrally broadened laser pulses.

26. A method of creating laser pulses, comprising the steps of
creating primary laser pulses with a laser source, and
spectrally broadening the primary laser pulses with a laser pulse spectral broadening apparatus according to claim 1, and
output of spectrally broadened laser pulses.

27. The method according to claim 26, comprising a further step of
matching a beam mode of the laser source to a light field mode defined by the multi-pass cell device.

28. The method according to claim 26, comprising a further step of
temporally compressing the spectrally broadened laser pulses with a pulse compression device.

29. The method according to claim 26, comprising a further step of
temporally compressing the spectrally broadened laser pulses with the multi-pass cell device.
